(19) United States
(12) Patent Application Publication
(10) Pub. No.: US 2012/0278030 A1
(43) Pub. Date: Nov. 1, 2012

(54) COMPUTING DEVICE AND METHOD FOR CONFIGURING ASSEMBLY INFORMATION OF A DATA CENTER

(75) Inventors: XIAO-JUN FU, Shenzhen City (CN); GUANG-JIAN WANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/397,687

(22) Filed: Feb. 16, 2012

(30) Foreign Application Priority Data
Apr. 28, 2011 (CN) 201110108928.8

(51) Int. Cl. G06F 15/00

(52) U.S. Cl. 702/150

(57) ABSTRACT

In a method for configuring assembly information of a data center using a computing device, the data center includes racks, and each of the racks includes data nodes. Each of the data nodes includes drawers, and each of the drawers has one or more motherboards and hard disks. The method determines a placement position of each of the motherboards in each of the drawers according to the center of gravity of the motherboard and the center point of the drawer, and determines a placement position of each of the hard disks according to the center of gravity of the hard disk and the center point of the drawer. The method determines a placement position of each of the drawers in the data node, and generates a report of the data center accordingly which can be used for assembly and reference relating to the data center.

### BACKGROUND

### 1. Technical Field

The embodiments of the present disclosure relate to management of configuration information of data centers, and more particularly to a computing device and method for configuring assembly information of a data center.

2. Description of related art

A data center may contain a number of data processing devices, such as hundreds of hard disks and motherboards. In order to ensure that each of the processing devices works normally, these data processing devices need to be assembled in a stable fashion in the data center. It is difficult to configure assembly information for the data center when a great number of data processing devices are used. Therefore, it is desirable to have a method for configuring assembly information of the data center, to address the above-mentioned problems.

### BRIEF DESCRIPTION OF THE DRAWINGS

FIG. 1 is a block diagram of one embodiment of a computing device including a data center configuration system.

FIG. 2 is a flowchart of one embodiment of a method for configuring assembly information of a data center using the computing device of FIG. 1.

FIG. 3 is a schematic diagram illustrating an example of the configuration of a data center.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

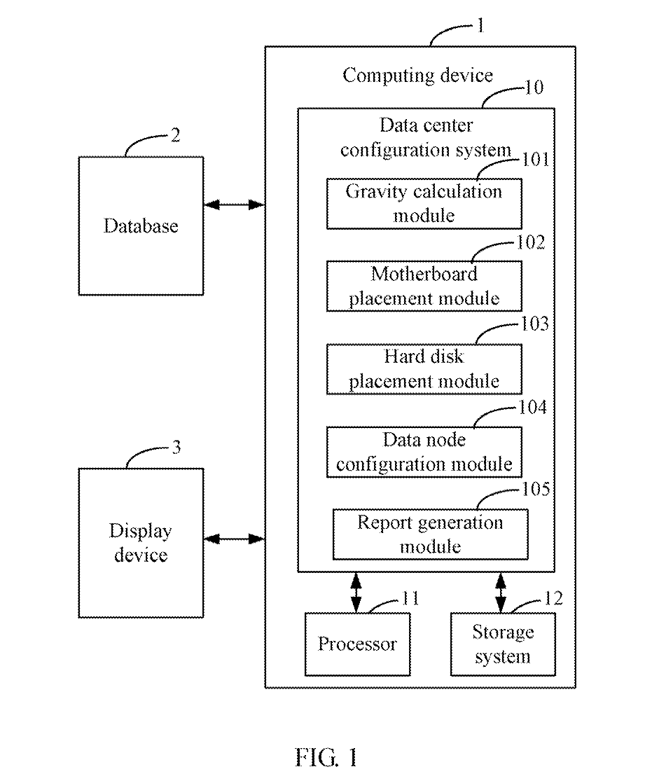

FIG. 1 is a block diagram of one embodiment of a computing device 1 including a data center configuration system 10. The computing device 1 may further include at least one processor 11 and a storage system 12. In the embodiment, the computing device 1 may be a computer or a server, for example. The data center configuration system 10 is operable to configure assembly information for a data center that is installed with a number of data processing devices (e.g., 200) are installed, such as a plurality of motherboards and hard disks.

The assembly information may include a placement position of each of the motherboards, a placement position of each of the hard disks, and a placement position of each of the drawers in the data center.

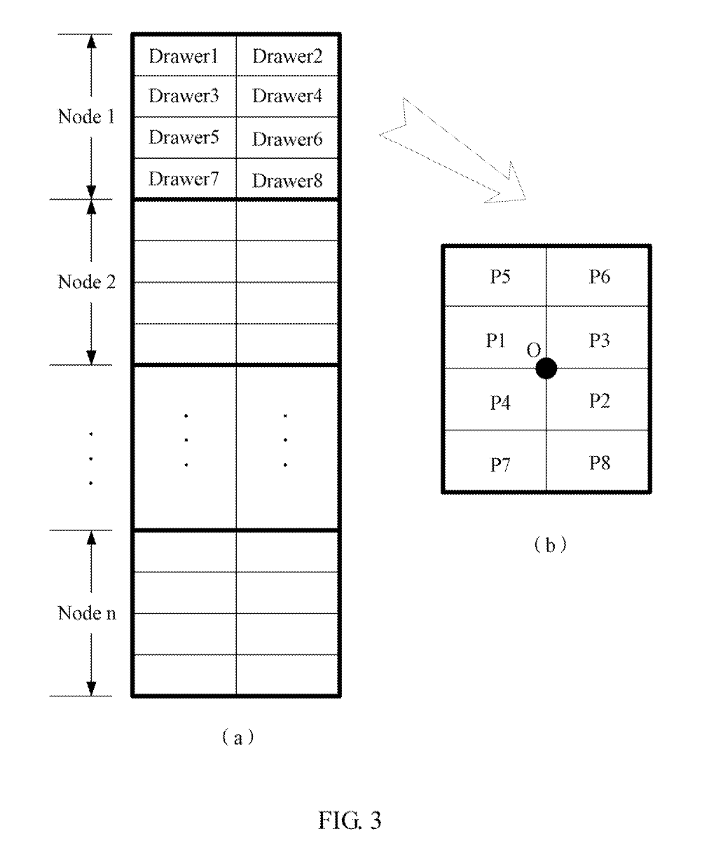

Referring to FIG. 3, the data center includes a plurality of racks (only one rack is shown in FIG. 3a). Each of the racks includes a plurality of data nodes, such as node_1, node_2, . . . , and node_n, as shown in FIG. 3a. Each of the data nodes includes a plurality of drawers, such as drawer_1, drawer_2, . . . , and drawer 8 as shown in FIG. 3a. Each of the drawers contains one or more motherboards and hard disks.

In the embodiment, the computing device 1 electronically connects to a database 2 and a display device 3. The database 2 stores hardware configuration information of the data center and other relevant information (order information) of the data center, including a weight of each of the motherboards, a weight of each of the hard disks, and a size of each of the drawers of the data center. The display device 3 displays the assembly information of the data center when the data center is configured.

The data center configuration system 10 may include a plurality of functional modules that are stored in the storage system 12 and executed by the at least one processor 11, and automatically configure assembly information for the data center according to the order information. In one embodiment, the storage system 12 may be an internal storage system, such as a random access memory (RAM) for the temporary storage of information, and/or a read only memory (ROM) for the permanent storage of information. In some embodiments, the storage system 12 may also be an external storage system, such as an external hard disk, a storage chipset, or a data storage medium.

In one embodiment, the data center configuration system 10 includes a gravity calculation module 101, a motherboard placement module 102, a hard disk placement module 103, a data node configuration module 104, and a report generation module 105. The modules 101-105 may comprise computerized instructions in the form of one or more programs that are stored in the storage system 12 and executed by the at least one processor 11 to provide functions for implementing the modules. A detailed description of each module will be given in the following paragraphs.

In general, the word “module,” as used herein, refers to logic embodied in hardware or firmware, or to a collection of software instructions, written in a programming language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, flash memory, and hard disk drives.

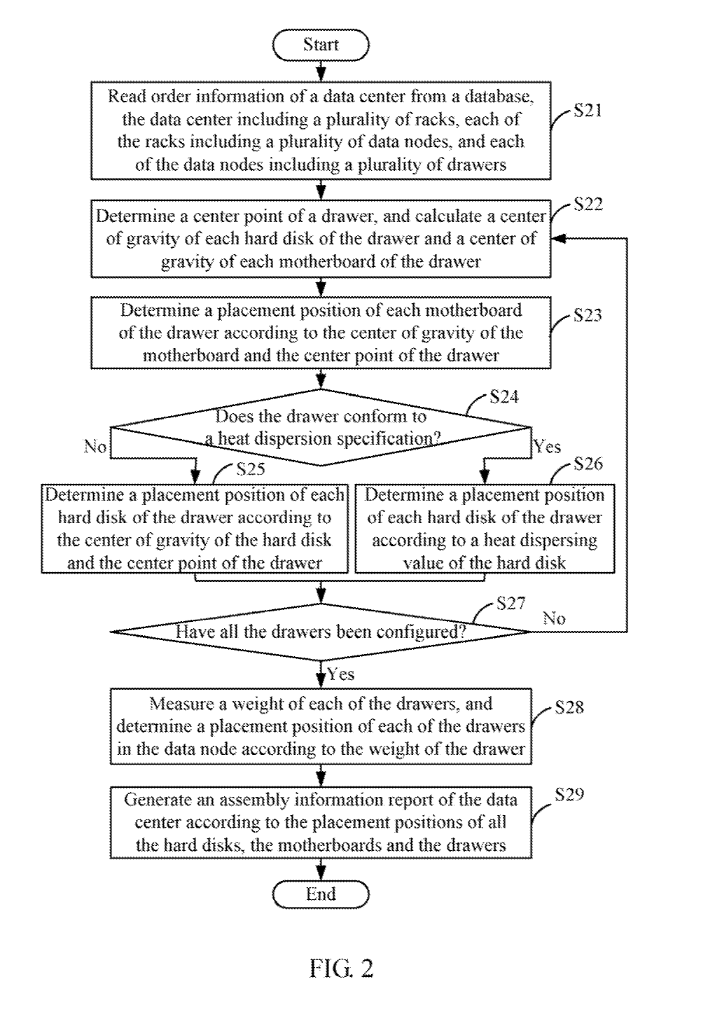

FIG. 2 is a flowchart of one embodiment of a method for configuring assembly information of a data center using the computing device 1 of FIG. 1. Depending on the embodiment, additional blocks may be added, others removed, and the ordering of the blocks may be changed.

In block S21, the gravity calculation module 101 reads order information of the data center from the database 2. In the embodiment, the data center includes a plurality of racks, and each of the racks includes a plurality of data nodes, such as node_1, node_2, . . . , and node_n, as shown in FIG. 3a. Each of the data nodes includes a plurality of drawers, such as drawer_1, drawer_2, . . . , and drawer_8 as shown in FIG. 3a. Each of the drawers can be installed with one or more motherboards and hard disks. For example, two motherboards (e.g., MB_1 and MB_2) and six hard disks (e.g., HD_1, HD_2, . . . , and HD_6) may be placed in drawer_1.

In block S22, the gravity calculation module 101 selects a drawer to be configured from the drawers and determines a center point of the drawer according to the size of the drawer, calculates a center of gravity (CoG) of each of the hard disks according to the weight of the hard disk, and calculates a center of gravity of each of the motherboards according to the weight of the motherboard. Referring to FIG. 3b, the center point of the drawer_1 is a point “O”, which is represented by a coordinate value (0, 0).

In block S23, the motherboard placement module 102 determines a placement position of each motherboard of the drawer according to the center of gravity of the motherboard and the center point of the drawer. In one embodiment, the motherboard placement module 102 selects a position of the drawer which has the closest possible distance to the center of gravity of the motherboard and the center point of the drawer, as the placement position of the motherboard. Referring to FIG. 3b, the motherboard (MB_1) is placed on the position P1, and the motherboard (MB_2) is placed on the position P2, for example.

In block S24, the hard disk placement module 103 determines whether the drawer conforms to a heat dispersion specification according to the order information of the data center. If the drawer does not conform to the heat dispersion specification, block S25 is implemented. Otherwise, if the drawer conforms to the heat dispersion specification, block S26 is implemented. In one embodiment, the heat dispersion specification specifics different heat dispersing values of hardware components of the data center, such as the motherboards and the hard disks.

In block S25, the hard disk placement module 103 determines a placement position of each hard disk of the drawer according to the center of gravity of the hard disk and the center point of the drawer. In one embodiment, the hard disk placement module 103 selects a position of the drawer which is closest to the center of gravity of the hard disk and the center point of the drawer as the placement position of the hard disk. Referring to FIG. 3b, the hard disk (HD_1) is placed on the position P3, and the hard disk (HD_2) is placed on the position P4, for example.

In block S26, the hard disk placement module 103 obtains a heat dispersing value of the hard disk from the order information of the data center, and determines a placement position of each hard disk of the drawer according to the heat dispersing value of the hard disk. In one embodiment, the hard disk placement module 103 selects a position of the drawer which has the farthest possible distance from the center point of the drawer for a hard disk having the greatest heat dispersing value, and selects a closer distance to the center point of the drawer for a hard disk having a lesser heat dispersing value. Referring to FIG. 3b, the heat dispersing values of the hard disks HD_1 and HD_2 are both less than the heat dispersing values of the hard disks HD_3, . . . , and HD_6. The hard disks HD_1 and HD_2 are thus placed on the position P3 and P4, and the hard disk HD_3, . . . , and HD_6 are placed on the position P5, . . . , and P8.

In block S27, the data node configuration module 104 determines whether all of the drawers have been configured, for example, drawer_1, . . . , and drawer_8 as shown in FIG. 3a. If all of the drawers have been configured, block S28 is implemented. Otherwise, if one drawer remains to be configured, block S22 is repeated.

In block S27, the data node configuration module 104 measures a weight of each of the drawers, and determines a placement position of each of the drawers in the data node according to the weight of the drawer. In one embodiment, the heavier drawers have a placement position lower in the data node. Such placement of the drawers in the data node can ensure the data center is more stable and robust against knocks and accidents in the data center premises, so as to prolong the usage time of the data center.

In block S28, the report generation module 105 generates an assembly information report of the data center according to the placement positions of the hard disks, the placement positions of the motherboard, and the placement positions of the drawers. The report generation module 105 further stores the assembly information report of the data center into the database 2, or displays the assembly information report of the data center on the display device 3. The user simply needs to refer to the assembly information report to assemble the data center conveniently and correctly.

All of the processes described above may be embodied in, and fully automated via, functional code modules executed by one or more general purpose processors of computing devices. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

Although certain disclosed embodiments of the present disclosure have been specifically described, the present disclosure is not to be construed as being limited thereto.

Various changes or modifications may be made to the present disclosure without departing from the scope and spirit of the present disclosure.

What is claimed is:

1. A computing device for configuring assembly information of a data center, the data center comprising a plurality of racks, each of the racks comprising a plurality of data nodes, each of the data nodes comprising a plurality of drawers, and each of the drawers installed with one or more motherboards and hard disks, the computing device comprising:
a storage system;
at least one processor; and
one or more programs stored in the storage system and executed by the at least one processor, the one or more programs comprising:
a gravity calculation module that reads order information of the data center from a database, determines a center point of each of the drawers according to a size of the drawer, calculates a center of gravity of each of the hard disks according to a weight of the hard disk, and calculates a center of gravity of each of the motherboards according to a weight of the motherboard;
a motherboard placement module that selects a drawer to be configured from the drawers, determines a placement position of each motherboard of the drawer according to the center of gravity of the motherboard and the center point of the drawer;
a hard disk placement module that determines whether the drawer conforms to a heat dispersion specification according to the order information of the data center, determines a placement position of each hard disk of the drawer according to the center of gravity of the hard disk and the center point of the drawer if the drawer does not conform to the heat dispersion specification, obtains a heat dispersion value of each hard disk of the drawer from the order information of the data center and determines a placement position of each hard disk of the drawer according to the heat dispersion value of the hard disk if the drawer conforms to the heat dispersion specification;
a data node configuration module that measures a weight of each of the drawers when all the drawers have been configured, and determines a placement position of each of the drawers in the data node according to the weight of the drawer; and
a report generation module that generates an assembly information report of the data center according to the placement positions of the hard disks, the placement positions of the motherboards, and the placement positions of the drawers.

2. The computing device according to claim 1, wherein the report generation module further stores the assembly information report of the data center into the database, and displays the assembly information report of the data center on a display device.

3. The computing device according to claim 1, wherein the order information of the data center comprises a weight of each of the motherboards, a weight of each of the hard disks, and a size of each of the drawers.

4. The computing device according to claim 1, wherein the motherboard placement module selects a position which has the closet distance to the center of gravity of the motherboard and the center point of the drawer as the placement position of the motherboard.

5. The computing device according to claim 1, wherein the hard disk placement module selects a position which has the closet distance to the center of gravity of the hard disk and the center point of the drawer as the placement position of the hard disk.

6. The computing device according to claim 1, wherein the hard disk placement module selects a position which has the farthest possible distance from the center point of the drawer for a hard disk having the greatest heat dispersing value, and selects a closer distance to the center point of the drawer for a hard disk having a lesser heat dispersing value.

7. A method for configuring assembly information of a data center, the data center comprising a plurality of racks, each of the racks comprising a plurality of data nodes, each of the data nodes comprising a plurality of drawers, and each of the drawers installed with one or more motherboards and hard disks, the method comprising:
(a) reading order information of the data center from a database;
(b) determining a center point of each of the drawers according to a size of the drawer, calculating a center of gravity of each of the hard disks according to a weight of the hard disk, and calculating a center of gravity of each of the motherboards according to a weight of the motherboard;
(c) selecting a drawer to be configured from the drawers, and determining a placement position of each motherboard of the drawer according to the center of gravity of the motherboard and the center point of the drawer;
(d) determining whether the drawer conforms to a heat dispersion specification according to the order information of the data center;
(e) determining a placement position of each hard disk of the drawer according to the center of gravity of the hard disk and the center point of the drawer, if the drawer does not conform to the heat dispersion specification;
(f) obtaining a heat dispersion value of each hard disk of the drawer from the order information of the data center and determining a placement position of each hard disk of the drawer according to the heat dispersion value of the hard disk, if the drawer conforms to the heat dispersion specification;
(g) measuring a weight of each of the drawers when all the drawers have been configured, and determining a placement position of each of the drawers in the data node according to the weight of the drawer; and
(h) generating an assembly information report of the data center according to the placement positions of the hard disks, the placement positions of the motherboards, and the placement positions of the drawers.

8. The method according to claim 7, further comprising:
storing the assembly information report of the data center into the database, and displaying the assembly information report of the data center on a display device.

9. The method according to claim 7, wherein the order information of the data center comprises a weight of each of the motherboards, a weight of each of the hard disks, and a size of each of the drawers.

10. The method according to claim 7, wherein the step (c) comprises:
selecting a position which has the closet distance to the center of gravity of the motherboard and the center point of the drawer as the placement position of the motherboard.

11. The method according to claim 7, wherein the step (e) comprises:
selecting a position which has the closet distance to the center of gravity of the hard disk and the center point of the drawer as the placement position of the hard disk.

12. The method according to claim 7, wherein the step (f) comprises:
selecting a position which has the farthest possible distance from the center point of the drawer for a hard disk having the greatest heat dispersing value; and
selecting a closer distance to the center point of the drawer for a hard disk having a lesser heat dispersing value.

13. A non-transitory storage medium having stored thereon instructions that, when is executed by at least one processor of a computing device, causes the computing device to perform a method for configuring assembly information of a data center, the data center comprising a plurality of racks, each of the racks comprising a plurality of data nodes, each of the data nodes comprising a plurality of drawers, and each of the drawers installed with one or more motherboards and hard disks, the method comprising:
(a) reading order information of the data center from a database;
(b) determining a center point of each of the drawers according to a size of the drawer, calculating a center of gravity of each of the hard disks according to a weight of the hard disk, and calculating a center of gravity of each of the motherboards according to a weight of the motherboard;
(c) selecting a drawer to be configured from the drawers, and determining a placement position of each motherboard of the drawer according to the center of gravity of the motherboard and the center point of the drawer;
(d) determining whether the drawer conforms to a heat dispersion specification according to the order information of the data center;
(e) determining a placement position of each hard disk of the drawer according to the center of gravity of the hard disk and the center point of the drawer, if the drawer does not conform to the heat dispersion specification;
(f) obtaining a heat dispersion value of each hard disk of the drawer from the order information of the data center and determining a placement position of each hard disk of the drawer according to the heat dispersion value of the hard disk, if the drawer conforms to the heat dispersion specification;
(g) measuring a weight of each of the drawers when all the drawers have been configured, and determining a placement position of each of the drawers in the data node according to the weight of the drawer; and
(h) generating an assembly information report of the data center according to the placement positions of the hard disks, the placement positions of the motherboards, and the placement positions of the drawers.

14. The storage medium according to claim 13, wherein the method further comprises:
storing the assembly information report of the data center into the database, and displaying the assembly information report of the data center on a display device.

15. The storage medium according to claim 13, wherein the order information of the data center comprises a weight of each of the motherboards, a weight of each of the hard disks, and a size of each of the drawers.

16. The storage medium according to claim 13, wherein the step (c) comprises:
selecting a position which has the closet distance to the center of gravity of the motherboard and the center point of the drawer as the placement position of the motherboard.

17. The storage medium according to claim 13, wherein the step (e) comprises:
selecting a position which has the closet distance to the center of gravity of the hard disk and the center point of the drawer as the placement position of the hard disk.

18. The storage medium according to claim 13, wherein the step (f) comprises:
selecting a position which has the farthest possible distance from the center point of the drawer for a hard disk having the greatest heat dispersing value; and
selecting a closer distance to the center point of the drawer for a hard disk having a lesser heat dispersing value.

19. The storage medium according to claim 13, wherein the storage medium is selected from the group consisting of a hard disk drive, a compact disc, a digital video disc, and a tape drive.
